(19) United States
(12) Patent Application Publication
(10) Pub. No.: US 2015/0328755 A1
(43) Pub. Date: Nov. 19, 2015

(54) Electrical Conduit Locknut Socket

(71) Applicant: Gregory Todd Marshall, Lubbock, TX (US)

(72) Inventor: Gregory Todd Marshall, Lubbock, TX (US)

(21) Appl. No.: 14/597,180

(22) Filed: Jan. 14, 2015

(51) Int. Cl. B25B 23/10; B25B 13/50; B25B 13/06

(52) U.S. Cl. CPC B25B 23/108; B25B 13/065; B25B 13/50

(57) ABSTRACT

A socket for holding electrical conduit locknuts. The socket comprising a cylindrical socket body with a top portion and a bottom portion. An annular threaded receiving ring may be disposed on the top portion of the cylindrical socket body to engage an electrical conduit locknut. The annular threaded receiving ring is adapted to lock the electrical conduit locknut. The socket further includes a coupling member having a multisided opening at the bottom portion of the cylindrical socket body. The socket holds electrical conduit locknuts in place for easy assembly and disassembly. The socket may be provided in a plurality of sizes in order to accommodate electrical conduit locknuts of different sizes.

### CROSS REFERENCE TO RELATED APPLICATION

This application claims the benefit of U.S. Provisional Application No. 61/927,141 filed on Jan. 14, 2014. The above identified provisional patent application is herein incorporated by reference in its entirety to provide continuity of disclosure.

### FIELD OF THE INVENTION

The present invention relates to sockets, and more particularly to sockets for holding electrical conduit locknuts in place for easy assembly and disassembly.

### BACKGROUND OF THE INVENTION

There are many different types of electrical conduit connectors developed to connect conduit-carrying electrical circuits. A common way of securing the conduit connectors is to use an electrical conduit locknut. A locknut is an annular threaded ring with lugs extending from its periphery. A locknut typically has a plurality of lugs about the lock nut periphery which are used for tightening of the lock nut about the threads of a conduit end opening. These lock nuts are typically tightened and loosened by someone such as an electrician during installation or disassembly of an electrical conduit structure.

Currently, there is not an effective, time-oriented tool specifically designed to tighten or loosen locknuts, much less hold them securely in place. In lieu of a specially designed tool, many people in the industry use tools that are not conventionally used to tighten or loosen locknuts, such as hammers, screwdrivers, needle nose pliers, slip joint pliers, etc. Because these tools are not specifically designed to tighten or loosen a locknut, they can be unsafe, impractical, and a waste of time.

For example, electricians have typically tightened or loosened locknuts by placing the tip of a flat edge screwdriver against the lug of a locknut and striking the handle of a screwdriver with a hammer. This may lead to applying the incorrect amount of torque to the locknut, causing the locknut to be over tightened or inadequately tightened. Additionally, this may damage other equipment nearby, injure the user, or be inefficient.

Another common problem for designing a wrench or socket for locknuts, specifically electrical conduit locknuts, is that manufacturers vary the outside diameter of many locknuts. Furthermore, manufacturers may vary the number of lugs on the outside periphery of a locknut, as well as the size of each individual lug on a locknut. These factors make it difficult to design a socket that fits all locknuts of a particular diameter.

Therefore, there is a need for an electrical locknut socket which can be used to hold locknuts of certain sizes despite differences in locknut or lug configurations for easy assembly and disassembly.

### SUMMARY OF THE INVENTION

In view of the foregoing disadvantages inherent in the known types of locknut sockets now present in the prior art, the present invention provides a socket designed to engage with an electrical locknut and hold the locknut in place which can allow for easy assembly and disassembly of the electrical conduit locknut.

It is therefore an object of the present invention to provide a new and improved socket for holding electrical conduit locknuts that has all of the advantages of the prior art and none of the disadvantages.

Accordingly, one example of the present invention is a socket for holding electrical conduit locknuts. The socket comprises a cylindrical socket body with a top portion and a bottom portion. The interior wall of the cylindrical socket body slopes toward the central axis of the cylindrical socket body from the top portion of the cylindrical socket body to the bottom portion of the cylindrical socket body, forming a conical shape in the interior of the socket. The socket further comprises an annular threaded receiving ring on the top portion of the cylindrical socket. The annular threaded receiving ring engages an electrical conduit locknut and is adapted to lock the electrical conduit locknut. In order to lock the electrical conduit locknut in the socket, the circular area of the annular threaded receiving ring is equal to an outer diameter of the electrical conduit locknut. The socket further comprises a coupling member having a multisided opening at the bottom portion of the cylindrical socket body.

It is another object of the present invention to provide a socket with a cylindrical socket body that forms an aperture for a socket wrench drive. The aperture may have varying shapes and sizes to accommodate socket wrench drives of different shapes and sizes.

Another object of the present invention is to provide a socket comprising a cylindrical socket body with a plurality of sizes to accommodate electrical conduit locknuts of different sizes.

Yet another object of the present invention is to provide a socket comprising a cylindrical socket body that has a plurality of shapes to accommodate electrical conduit locknuts of varying shapes or lug configurations.

Yet another object of the present invention is to provide a socket with a annular threaded receiving ring that has a plurality of threading patterns to receive electrical conduit locknuts with varying lug shapes and sizes.

Yet another object of the present invention is to provide a socket where the cross sectional area of the cylindrical socket body adjacent its inner end is greater than the cross sectional area adjacent its outer end.

Another object of the present invention is provide a socket comprising a cylindrical socket body made from a tool metal including steel, aluminum, titanium and other low alloy steels.

Yet another object of the present invention is to provide a cylindrical socket body that enables standard sized electrical conduit locknuts to be tightened securely when the electrical conduit locknuts have a diameter in the range of 0.5 to 4 inches.

Other objects, features and advantages of the present invention will become apparent from the following detailed description taken in conjunction with the accompanying drawings.

### BRIEF DESCRIPTIONS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an overhead view of the socket according to one embodiment of the present invention.

FIG. 2 shows a side view of the socket with an electrical conduit locknut locked in the teeth of the socket according to one embodiment of the present invention.

FIG. 3 shows different sizes of the socket to match an electrical conduit locknut according to one embodiment of the present invention.

FIG. 4 shows an overhead view of the socket according to one embodiment of the present invention.

FIG. 5 shows a perspective view of the socket according to one embodiment of the present invention.

### DETAILED DESCRIPTION OF THE INVENTION

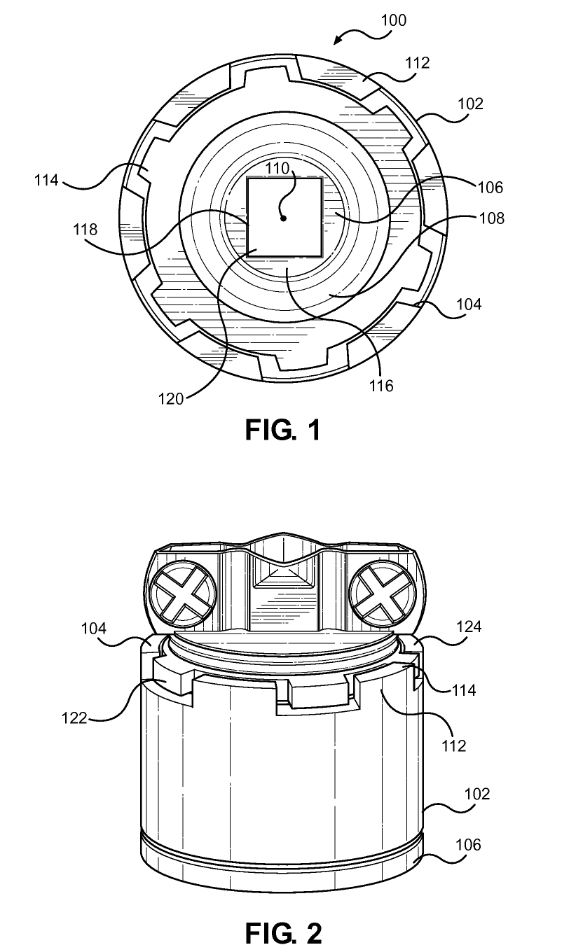

Reference is made herein to the attached drawings, FIGS. 1-5. Like reference numerals are used throughout the drawings to depict like or similar elements of the electrical conduit socket. For the purposes of presenting a brief and clear description of the present invention, the preferred embodiment will be discussed as used for electrical conduit locknuts. The figures are intended for representative purposes only and should not be considered to be limiting in any respect.

The present invention provides a socket for holding electrical conduit locknuts for easy assembly and disassembly. The present invention is adapted to provide a quick and effective way to tighten and loosen locknuts.

Referring now to FIGS. 1 and 4, embodiments of the socket 100 of the present invention is shown from an overhead view of the electrical socket. In the first embodiment, the socket 100 comprises a cylindrical socket body 102. It is contemplated that sockets 100 of differing size will be designed to accommodate locknuts of differing size, but the basic structure of the socket 100 will remain substantially the same. The sockets 100 of differing sizes have the same design and hold the electrical conduit locknuts 114 in place for tightening or loosening. The annular receiving ring 112 comprises teeth 124 extending around the peripheral edge thereof. The teeth 124 may be provided in a variety of shapes and sizes in order to accommodate the lugs of an electrical conduit locknut 114. The cylindrical socket body 102 can be made from a tool metal such as steel, aluminum, titanium and low alloy steels.

The cylindrical socket body 102 comprises a top portion 104 and a bottom portion 106. The interior wall 108 of the cylindrical socket body slopes toward the central axis 110 of the cylindrical socket body from the top portion 104 to the bottom portion 106. This creates conical shape in the interior of the socket 100.

The socket 100 further comprises an annular threaded receiving ring 112 on the top portion 104 of the cylindrical socket body 102. The annular threaded receiving ring 112 receives an electrical conduit locknut 114. The diameter of the annular threaded receiving ring 112 is equal to an outer diameter of the electrical conduit locknut 114 such that the annular threaded receiving ring 112 engages with and locks the electrical conduit locknut 114 in place. The annular threaded receiving ring 112 may have a plurality of threaded receiving ring patterns to receive electrical conduit locknuts 114 with varying lug shapes and sizes. For example, an electrical conduit locknut that has triangular lugs on the outer periphery would use a socket with an annular threaded receiving ring that has a corresponding triangular pattern.

The socket 100 further comprises a coupling member 116 having a multisided opening 118 at the bottom portion 106 of the cylindrical socket body 102. The multisided opening 118 at the bottom portion 106 of the cylindrical socket body 102 provides an aperture for fitting a socket wrench drive. Additionally, the cylindrical socket body 102 forms an aperture 118 for a socket wrench drive. The multisided opening can be configured to match the shape of a socket wrench drive. The bottom portion 106 of the cylindrical body 102 may further include a threaded member to removably attach coupling members. The coupling members have multisided openings adapted to receive socket wrench drives of different configurations. The multi-sided openings may be hexagonal, heptagonal, octagonal, etc.

Referring now to FIG. 2, there is a shown a side view of the socket with an electrical conduit locknut locked in the teeth of the socket according to one embodiment of the present invention. The annular threaded receiving ring 112 comprises teeth 124 at uniform intervals to engage lugs 122 of the electrical conduit locknut. FIG. 2 shows the teeth 124 of the annular threaded receiving ring 112 locking the lugs 122 of electrical conduit locknut 114. The teeth 124 engage the lugs 122 of the locknut 114, preventing rotational movement of the locknut 114 and thereby holding the locknut 114 in place. Furthermore, when rotational force is imparted onto the socket body 102, the engagement between the teeth 124 of the socket and the lugs 122 of the electrical conduit locknut 114 transfers that rotational force to the locknut 114, thus enabling complementarily-sized locknut rings to be tightened securely. In one embodiment of the present invention, the cylindrical socket body 102 enables standard sized electrical conduit locknuts 114 to be tightened securely when the electrical conduit locknuts 114 have a diameter in a range of 0.5 to 4 inches.

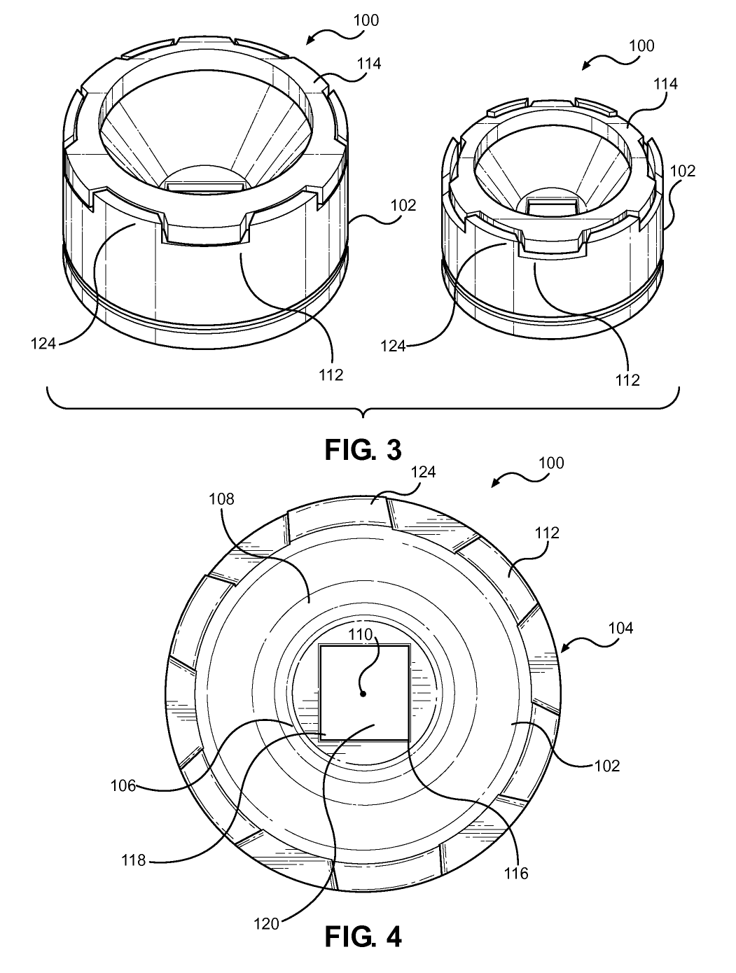

Referring now to FIG. 3, there is shown sockets 100 of differing sizes that are designed to accommodate electrical conduit locknuts 114 of differing sizes. The cylindrical socket body 102 retains the same basic conical structure. In both embodiments shown in FIG. 3, the annular threaded receiving ring comprise teeth 124 that extend horizontally and vertically to engage a locknut 114 of a specific size. The teeth 124 alternate around the periphery of the annular threaded receiving ring. The alternating spaces between the teeth 124 are adapted to receive the lugs 122 of the electrical conduit locknut 114 therein, allowing the electrical conduit locknut 114 to engage the socket 100. When the lugs of a locknut 114 are locked in the teeth 124 of the socket, an electrical apparatus can be easily tightened or removed from the conduit. It is also contemplated that a magnet may be inserted into the annular threaded receiving ring to retain the electrical conduit locknut.

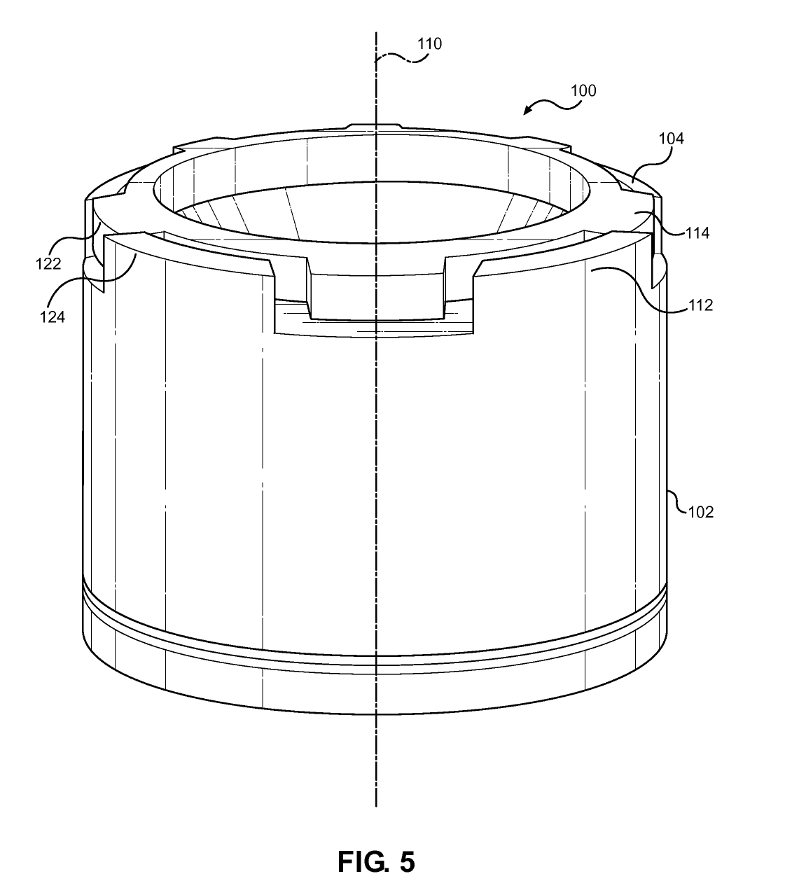

Referring now to FIG. 5, one embodiment of the present invention shows a perspective view of the socket 100 according to one embodiment of the present invention. The socket 100 is generally sized and shaped to enclose a circular area substantially equal to the ring diameter of the electrical conduit locknut 114 as shown in FIG. 5. The diameter of the annular threaded receiving ring 112 is equal to an outer diameter of the electrical conduit locknut 114 such that the annular threaded receiving ring 112 locks the electrical conduit locknut 114 in the socket.

The socket 100 is designed to receive the electrical conduit locknut 114 on the top portion 104 of the cylindrical socket body 102. The annular threaded receiving ring 112 engages and locks the electrical conduit locknut 114 on the socket 100. The outer diameter of the socket 100 closely matches the peripheral diameter of the electrical conduit locknut 114 when the teeth 124 are engaged with the lugs 122 of the locknut. The outer diameter of the socket 100 closely matching the peripheral diameter of the lug profile is especially important in applications where the socket 100 is utilized in close proximity to other objects.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A socket for securing electrical conduit locknuts, comprising:
a cylindrical socket body with a top portion and a bottom portion, wherein an interior wall of the cylindrical socket body slopes toward a central axis of the cylindrical socket body from the top portion to the bottom portion;
an annular threaded receiving ring disposed at the top portion of the cylindrical socket body adapted to engage an electrical conduit locknut, a diameter of the annular threaded receiving ring is equal to an outer diameter of the electrical conduit locknut; and
a coupling member having a multisided opening disposed at the bottom portion of the cylindrical socket body.

2) The apparatus of claim 1, wherein the bottom portion of the cylindrical socket body forms an aperture configured to receive a socket wrench drive.

3) The apparatus of claim 1, wherein the annular threaded receiving ring further comprises teeth at uniform intervals to engage lugs of the electrical conduit locknut.

4) The apparatus of claim 3, wherein the teeth are adapted to lock the electrical conduit locknut in place.

5) The apparatus of claim 1, wherein the cylindrical socket body has a plurality of sizes to accommodate electrical conduit locknuts.

6) The apparatus of claim 1, wherein the cylindrical socket body has a plurality of shapes to accommodate electrical conduit locknuts of varying shapes.

7) The apparatus of claim 1, wherein the annular threaded receiving ring has a plurality of threading patterns to receive electrical conduit locknuts with varying lug shapes and sizes.

8) The apparatus of claim 1, wherein a cross sectional area of the cylindrical socket body adjacent its inner end is greater than a cross sectional area adjacent its outer end.

9) The apparatus of claim 1, wherein the cylindrical socket body is made from a tool metal including steel, aluminum, titanium and low alloy steels.

10) The apparatus of claim 1, wherein the cylindrical socket body enables standard sized electrical conduit locknuts to be tightened securely when the electrical conduit locknuts have a diameter in a range of 0.5 to 4 inches.

11) The apparatus of claim 1, wherein a magnet is coupled to the annular threaded receiving ring to retain the electrical conduit locknut.

12) The apparatus of claim 1, wherein the cylindrical socket body is made of a magnetic material.

13) The apparatus of claim 1, wherein the bottom portion of the cylindrical body comprises a threaded member to removably attach the coupling member.

14) The apparatus of claim 13, wherein the coupling member comprises multisided openings adapted to receive socket wrench drives of different configurations.
